(19) United States
(12) Patent Application Publication
(10) Pub. No.: US 2017/0073946 A1
(43) Pub. Date: Mar. 16, 2017

(54) TUB SPOUT ASSEMBLY

(71) Applicant: Delta Faucet Company, Indianapolis, IN (US)

(72) Inventors: Robert Lee Arnold, Greensburg, IN (US); Yilin Tang, Guangzhou City (CN)

(21) Appl. No.: 15/266,665

(22) Filed: Sep. 15, 2016

Related U.S. Application Data
(60) Provisional application No. 62/219,496, filed on Sep. 16, 2015.

(51) Int. Cl. E03C 1/04; F16K 5/04; F16K 31/56

(52) U.S. Cl. CPC E03C 1/0409; F16K 31/563; F16K 5/0442; F16K 5/0457; E03C 2201/30

(57) ABSTRACT

A tub spout assembly includes a tub spout. The tub spout includes a spout inlet and a spout outlet. A diverter assembly is carried by the tub spout. The diverter assembly includes a diverter inlet and a diverter outlet. A handle is rotatable from a first position to a second position and vice versa relative to the tub spout. A sealing element is coupled to the handle so as to rotate with the handle. In the first position the sealing element is disposed apart from the diverter outlet to permit water to flow through the tub spout assembly and exit the tub spout assembly via the spout outlet. In the second position the sealing element obscures the diverter outlet to inhibit water from flowing through the spout outlet of the tub spout assembly. A torsion spring biases the handle and the sealing element toward the first position.

### CROSS-REFERENCE TO RELATED APPLICATION

The present application claims priority to U.S. Provisional Patent Application Ser. No. 62/219,496, filed Sep. 16, 2015, the disclosure of which is expressly incorporated herein by reference.

### BACKGROUND AND SUMMARY OF THE DISCLOSURE

The present disclosure generally relates to a tub spout assembly that selectively delivers water via a tub spout assembly outlet or a shower head. The present disclosure particularly relates to a tub spout assembly that includes a rotatable handle for selectively delivering water via the tub spout assembly outlet or diverting water for delivery via the shower head.

Tub spout assemblies often include a diverter for selectively delivering water via a tub spout assembly outlet or diverting water for delivery via a shower head. The diverter typically includes a rod that is translated linearly (that is, pushed or pulled) by a user to selectively deliver water via the tub spout assembly outlet or divert water for delivery via the shower head. Such a rod is a relatively conspicuous component that can reduce the aesthetic appeal of the entire tub spout assembly.

According to an illustrative embodiment of the present disclosure, a tub spout assembly delivers water and diverts water to a shower head. The tub spout assembly includes a tub spout. The tub spout includes a spout inlet that is configured to receive water. The tub spout further includes a spout outlet that is configured to deliver water from the tub spout assembly. A diverter assembly is carried by the tub spout. The diverter assembly includes a diverter inlet that is configured to receive water from the spout inlet and a diverter outlet that is configured to deliver water to the spout outlet. A handle is rotatably carried by the tub spout, and the handle is rotatable from a first position to a second position and vice versa relative to the tub spout. A sealing element is coupled to the handle so as to rotate with the handle from the first position to the second position and vice versa relative to the tub spout. In the first position the sealing element is disposed apart from the diverter outlet to permit water to flow through the tub spout assembly and exit the tub spout assembly via the spout outlet. In the second position the sealing element obscures the diverter outlet to inhibit water from flowing through the spout outlet of the tub spout assembly. A torsion spring is coupled to the handle and the sealing element. The torsion spring biases the handle and the sealing element toward the first position.

According to another illustrative embodiment of the present disclosure, a tub spout assembly delivers water and diverts water to a shower head. The tub spout assembly includes a tub spout that defines a longitudinal axis. The tub spout includes a spout inlet that is configured to receive water. The tub spout further includes a spout outlet that is configured to deliver water from the tub spout assembly. A diverter assembly is carried by the tub spout. The diverter assembly includes a diverter inlet that is configured to receive water from the spout inlet. The diverter assembly further includes a diverter outlet that is configured to deliver water to the spout outlet. The diverter outlet is disposed in a plane that is substantially perpendicular to the longitudinal axis. A handle is rotatably carried by the tub spout. The handle is rotatable from a first position to a second position and vice versa relative to the tub spout about the longitudinal axis. A sealing element is coupled to the handle so as to rotate with the handle from the first position to the second position and vice versa relative to the tub spout about the longitudinal axis. In the first position the sealing element is disposed apart from the diverter outlet to permit water to flow through the tub spout assembly and exit the tub spout assembly via the spout outlet. In the second position the sealing element obscures the diverter outlet to inhibit water from flowing through the spout outlet of the tub spout assembly.

Additional features and advantages of the present disclosure will become apparent to those skilled in the art upon consideration of the following detailed description of illustrative embodiments of the present disclosure.

### BRIEF DESCRIPTION OF THE DRAWINGS

FIG. 1 is a perspective view of an illustrative tub spout assembly, shown with a handle of the tub spout assembly rotated to a “bath” or first position in which water is delivered from an outlet of the tub spout assembly;

FIG. 2 is another perspective view of the tub spout assembly of FIG. 1, shown with the handle of the tub spout assembly rotated to a “shower” or second position in which water is not delivered from the outlet of the tub spout assembly and water is instead delivered from a shower head;

FIG. 3 is an exploded front perspective view of the tub spout assembly of FIG. 1;

FIG. 4 is an exploded rear perspective view of the tub spout assembly of FIG. 1;

FIG. 5 is a perspective longitudinal section view of the tub spout assembly along line 5-5 of FIG. 1;

FIG. 6 is a perspective longitudinal section view of the tub spout assembly along line 6-6 of FIG. 2;

FIG. 7 is a perspective cross section view of the tub spout assembly along line 7-7 of FIG. 1;

FIG. 8 is a perspective cross section view of the tub spout assembly along line 8-8 of FIG. 2;

FIG. 9 is a front perspective view of a first housing portion of a diverter assembly of the tub spout assembly of FIG. 1;

FIG. 10 is a rear perspective view of the first housing portion of FIG. 9;

FIG. 11 is a front perspective view of a portion of the diverter assembly of the tub spout assembly of FIG. 1;

FIG. 12 is a top perspective view of a sealing element of the diverter assembly of the tub spout assembly of FIG. 1;

FIG. 13 is a bottom perspective view of the sealing element of FIG. 12;

FIG. 14 is a bottom perspective view of a second housing portion of a diverter assembly of the tub spout assembly of FIG. 1;

FIG. 15 is a rear perspective view of the second housing portion of FIG. 14;

FIG. 16 is a perspective longitudinal section view of the tub spout assembly along line 5-5 of FIG. 1, with an operation torque and torques resisting rotation of the sealing element toward the second position illustrated;

FIG. 17 is a perspective longitudinal section view of the tub spout assembly along line 6-6 of FIG. 2, with an operation torque and torques resisting rotation of the sealing element toward the first position illustrated;

FIG. 18 is a perspective longitudinal section view of the tub spout assembly along line 6-6 of FIG. 2, with a water pressure threshold torque and torques resisting rotation of the sealing element toward the first position illustrated;

FIG. 19 is a perspective view of another illustrative tub spout assembly, shown with a handle of the tub spout assembly rotated to a “bath” or first position in which water is delivered from an outlet of the tub spout assembly;

FIG. 20 is another perspective view of the tub spout assembly of FIG. 19, shown with the handle of the tub spout assembly rotated to a “shower” or second position in which water is not delivered from the outlet of the tub spout assembly and water is instead delivered from a shower head;

FIG. 21 is a side cross section view of the tub spout assembly along line 21-21 of FIG. 19;

FIG. 22 is a perspective view of a portion of the tub spout assembly of FIG. 19 in the first position and with a second diverter housing portion shown in hidden lines;

FIG. 23 is a perspective view of a portion of the tub spout assembly of FIG. 20 in the second position and with the second diverter housing portion shown in hidden lines;

FIG. 24 is a perspective view of a portion of the tub spout assembly of FIG. 19;

FIG. 25 is a perspective view of a portion of a sealing element of the tub spout assembly of FIG. 19;

FIG. 26 is a perspective view of the second diverter housing portion of the tub spout assembly of FIG. 19; and

FIG. 27 is an end view of the second diverter housing portion of the tub spout assembly of FIG. 19.

### DETAILED DESCRIPTION OF THE DRAWINGS

The embodiments of the disclosure described herein are not intended to be exhaustive or to limit the disclosure to the precise forms disclosed. Rather, the embodiments described herein enable one skilled in the art to practice the disclosure.

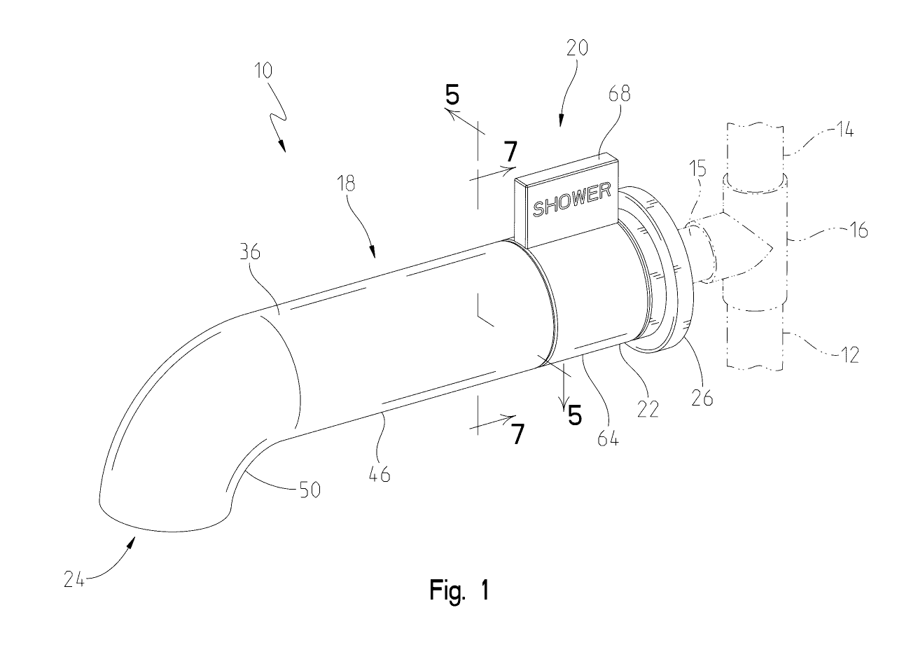

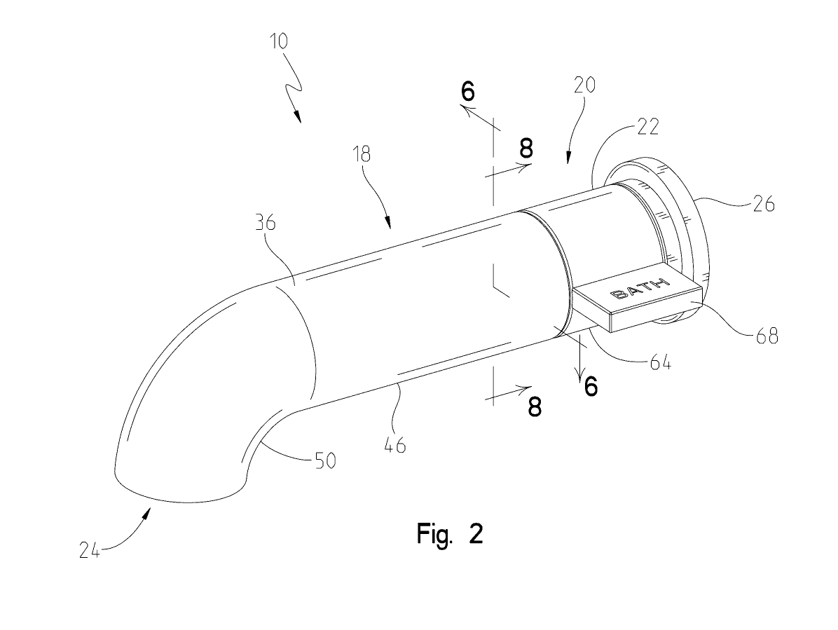

With reference initially to FIGS. 1 and 2 of the drawings, an illustrative tub spout assembly 10 of the present disclosure is configured to couple to a water delivery pipe or riser 12 and a shower head pipe or riser 14 via a tub spout pipe 15 and a T-joint 16. The tub spout assembly 10 generally includes a tub spout 18 that carries a diverter assembly 20. A handle 22 of the diverter assembly 20 may rotate to a first, “bath”, or “tub” position (see FIG. 1) in which the tub spout assembly 10 delivers water received from the water delivery pipe 12 to a spout outlet 24. Illustratively, the diverter assembly 20 may rotate to the first position due to manual manipulation by a user or a force applied by a spring. The handle 22 may also rotate to a second or “shower” position (see FIG. 2) in which the tub spout assembly 10 inhibits water flow therethrough and does not deliver water to the spout outlet 24. Instead, water from the water delivery pipe 12 is delivered to the shower head pipe 14 and a shower head (not shown) coupled thereto. Illustratively, the diverter assembly 20 may rotate to the second position due to manual manipulation by the user. These and other features of the tub spout assembly 10 are described further in the following paragraphs.

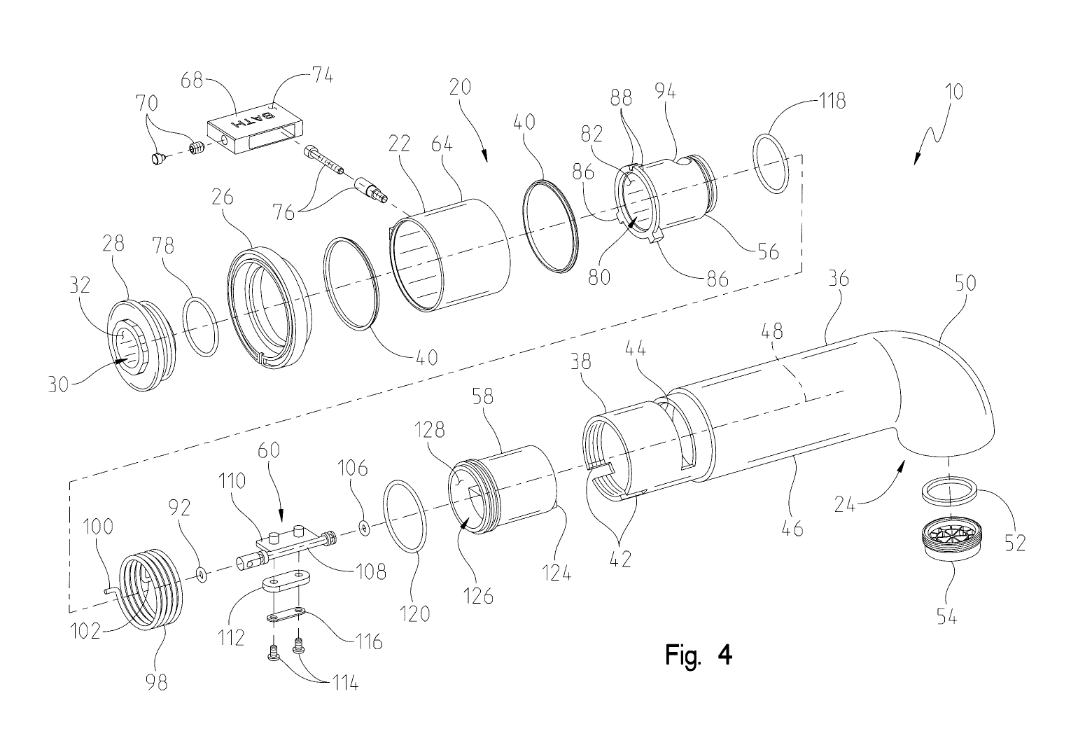

With reference to FIGS. 1-6, the tub spout 18 includes an escutcheon or trim 26 that is configured to abut a wall (not shown) carrying the tub spout assembly 10. The escutcheon 26 surrounds and couples to an inlet coupling 28, illustratively through cooperating threads. The inlet coupling 28 couples to the tub spout pipe 15 and includes a spout inlet 30 for receiving water from the water delivery pipe 12. The inlet 30 couples to a passageway 32, and the passageway 32 couples to an outlet 34, which delivers water to the diverter assembly 20 as described in further detail in the following paragraphs.

The inlet coupling 28 and the escutcheon 26 couple to a spout housing 36 that defines the spout outlet 24. The spout housing 36 includes a proximal or first portion 38 that rotatably carries the handle 22, illustratively, via gaskets 40. Illustratively, the first portion 38 includes an outer diameter, which is less than other diameters of the spout housing 36, as described in further detail below. The spout housing 36 also includes two notches 42 to facilitate internally receiving the diverter assembly 20 as described in further detail below. The spout housing 36 further includes an arcuate slot 44 to receive a portion of the handle 22 as described in further detail below. The arcuate slot 44 extends about a portion of the circumference of the first portion 38 of the spout housing 36.

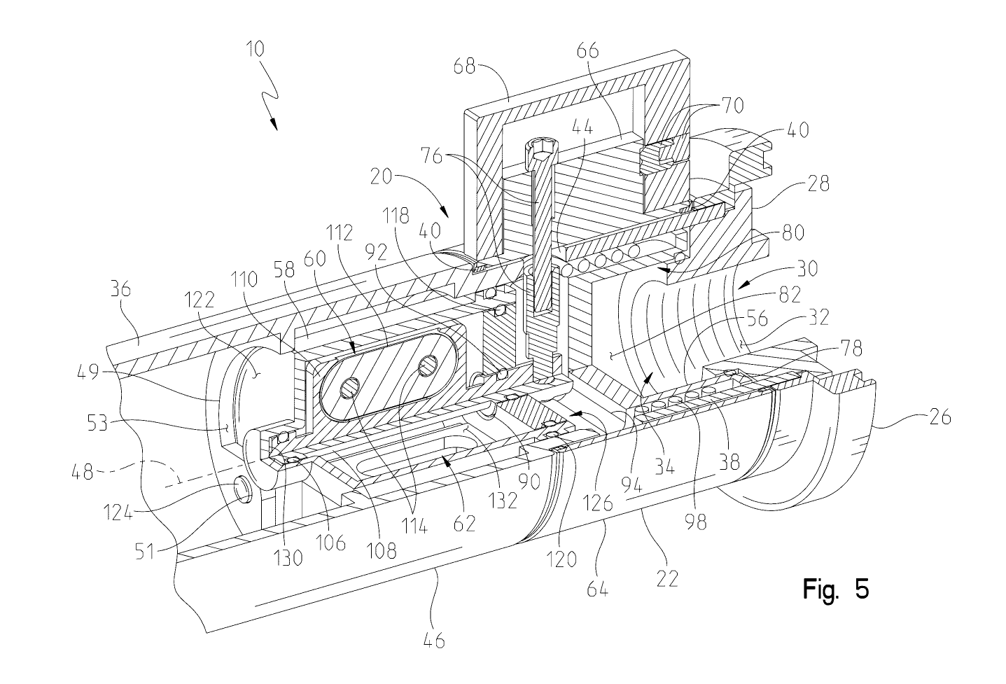

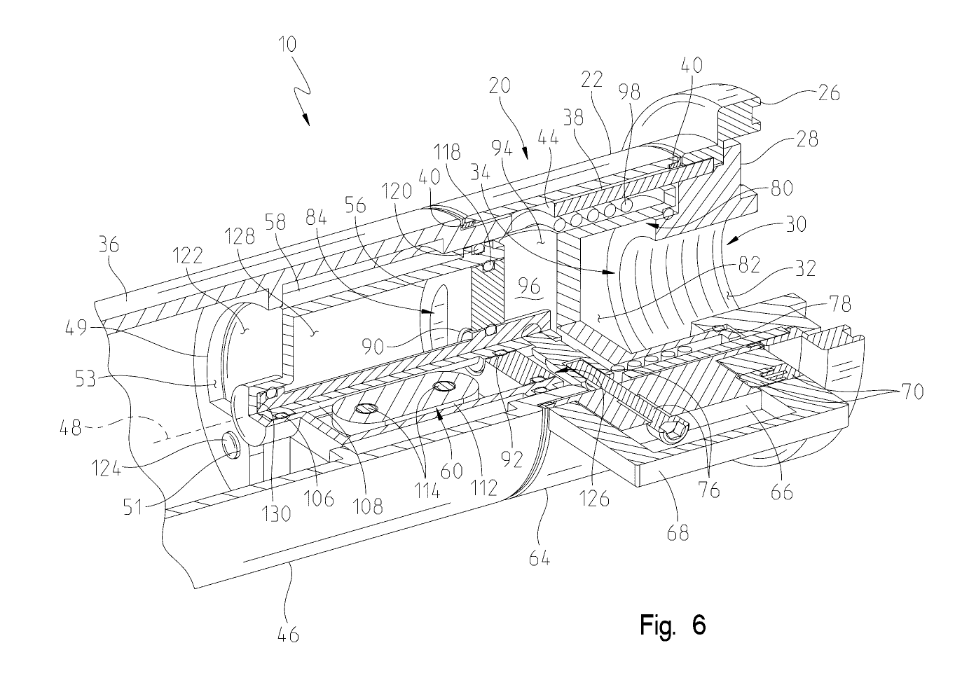

The spout housing 36 further includes an intermediate or second portion 46 coupled to the first portion 38. Illustratively, the second portion 46 monolithically couples to the first portion 38. The second portion 46 defines and extends along a longitudinal axis 48 of the tub spout assembly 10. Illustratively, the second portion 46 has a hollow, generally cylindrical shape. Illustratively, the second portion 46 includes an outer diameter that is greater than the outer diameter of the first portion 38. The second portion 46 further includes a transversely-extending internal wall 49 (see FIGS. 5 and 6) that includes holes 51. The holes 51 receive the diverter assembly 20 as described in further detail below. The internal wall 49 also includes an aperture 53 to permit flow through the second portion 46 of the spout housing 36.

The spout housing 36 further includes a distal or third portion 50 coupled to the second portion 46 opposite the first portion 38. Illustratively, the third portion 50 monolithically couples to the second portion 46. The third portion 50 extends away from the longitudinal axis 48 of the tub spout assembly 10 and defines the spout outlet 24 opposite the second portion 46. Illustratively, the third portion 50 includes a hollow, generally curved cylindrical shape.

The first and second portions of spout housings in accordance with the present disclosure may take various shapes and forms. For example, a first portion of a spout housing could have a different axisymmetric shape, such as a frusto-conical shape, or a non-axisymmetric shape. As another example, a second portion of a spout housing could extend transversely away from the first portion and the longitudinal axis.

The spout outlet 24 illustratively includes a gasket 52 and an aerator or stream straightener 54. Illustratively, the stream straightener 54 threadably couples to the third portion 50 of the spout housing 36 at the spout outlet 24.

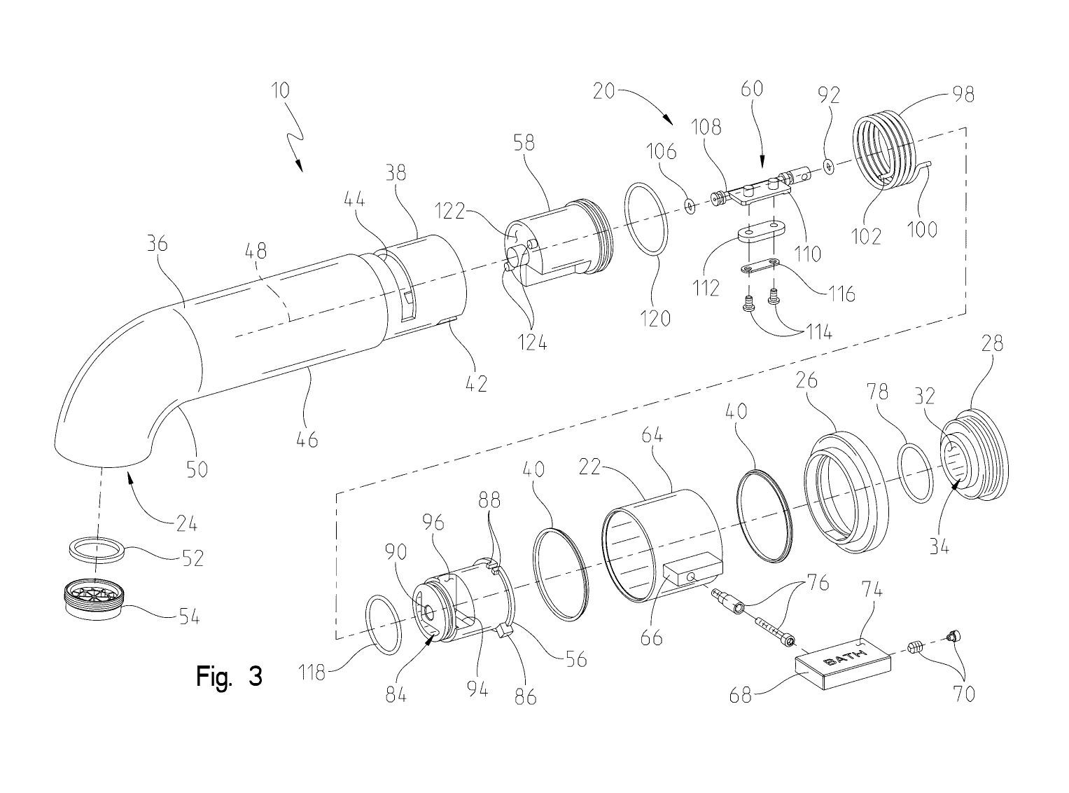

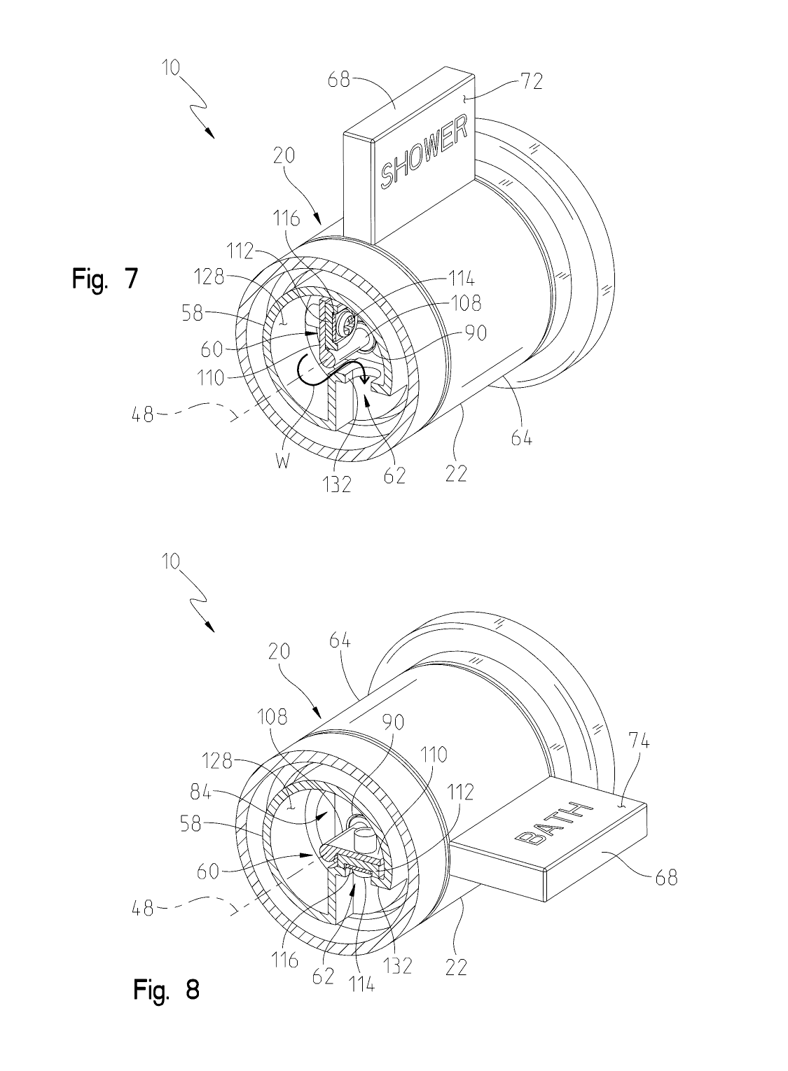

With continued reference to FIGS. 3-6 and additional reference to FIGS. 7 and 8, the diverter assembly 20 includes the handle 22 for selectively positioning the tub spout assembly 10 in the first (or bath) position (see FIGS. 5 and 7) or the second (or shower) position (see FIGS. 6 and 8). Illustratively, the handle 22 rotates substantially 90 degrees (that is, 90 degrees±5 degrees) about longitudinal axis 48 from the first position to the second position (e.g., clockwise) and vice versa (e.g., counter-clockwise). The diverter assembly 20 also generally includes a first diverter housing portion 56 and a second diverter housing portion 58 that receive water from the inlet coupling 28. The housing portions 56 and 58 rotatably and internally carry a sealing element 60. The sealing element 60 couples to the handle 22 so as to rotate with the handle 22 from the first position to the second position and vice versa. In the first position, the sealing element 60 is disposed apart from a diverter outlet 62 defined by the second diverter housing portion 58 to permit water to flow through the tub spout assembly 10 and exit via the spout outlet 24. Illustratively and referring to FIG. 7, water generally flows in the direction of arrow W when the sealing element 60 is in the first position. In the second position of FIG. 8, the sealing element 60 obscures the diverter outlet 62 to inhibit water from flowing through the spout outlet 24 of the tub spout assembly 10. These and other features of the diverter assembly 20 are described further in the following paragraphs.

The handle 22 includes a first portion 64 that is rotatably carried by the spout housing 36 via gaskets 40. Illustratively, the first portion 64 has a generally cylindrical shape. Illustratively, the first portion 64 is concentric with and rotates about the longitudinal axis 48. The outer diameter of the first portion 64 may be substantially the same (that is, within 0.1 in.) as the outer diameter of the second portion 46 of the spout housing 36. Such diameters may provide a “continuous” appearance between the first portion 64 of the handle 22 and the second portion 46 of the spout housing 36.

The handle 22 illustratively also includes a boss or tab 66 coupled to the first portion 64. Illustratively, the tab 66 monolithically couples to the first portion 64. Illustratively, the tab 66 has a three-dimensional generally rectangular shape that extends transversely away from the first portion 64 and the longitudinal axis 48.

The handle 22 illustratively further includes a grip or cover 68 coupled to the tab 66. Illustratively, the cover 68 couples to the tab 66 by internally receiving the tab 66 and via a fastener, such as a set screw assembly 70. Illustratively, the cover 68 has a three-dimensional generally rectangular shape that extends transversely away from the first portion 64 and the longitudinal axis 48. The cover 68 includes a first surface 72 that is visible when the handle 22 is in the first or bath position (see FIG. 7) and a second surface 74 that is visible when the handle 22 is in the second or shower position (see FIG. 8). Optionally, the first surface 72 includes the word “shower” to indicate that water may be delivered via the shower head by rotating the handle 22. Alternatively, the first surface 72 may include the letter “S” or a depiction of a shower head. Alternatively, the first surface 72 may include the words “bath” or “tub”, the letters “B” or “T”, or a depiction of a tub spout to indicate that the tub spout assembly 10 is in the bath position. Optionally, the second surface 74 includes the word “bath” to indicate that water may be delivered via the tub spout assembly 10 by rotating the handle 22. Alternatively, the second surface 74 may include the word “tub”, the letters “B” or “T”, or a depiction of a tub spout. Alternatively, the second surface 74 may include the word “shower”, the letter “S”, or a depiction of a shower head to indicate that the tub spout assembly 10 is in the shower position.

The handle 22 illustratively further includes a lever, such as a fastener and specifically a screw assembly 76, that couples the tab 66 to the sealing element 60 such that the sealing element 60 rotates with the handle 22. Illustratively, the screw assembly 76 extends through the slot 44 of the spout housing 36 to couple the tab 66 to the sealing element 60.

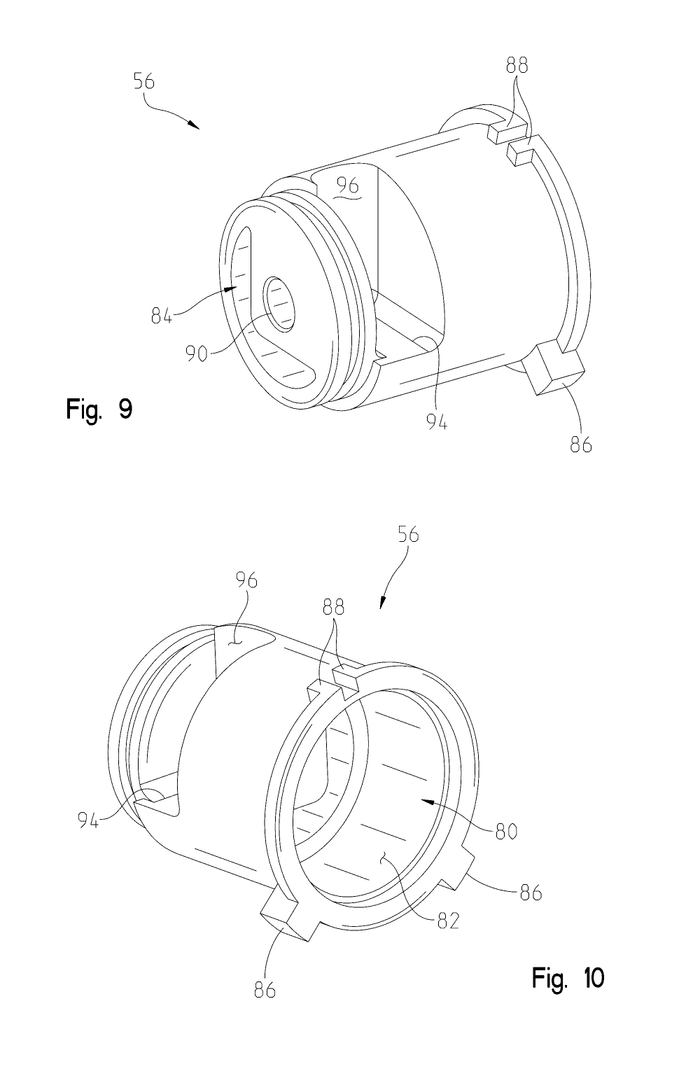

With continued reference to FIGS. 3-8 and additional reference to FIGS. 9 and 10, the first diverter housing portion 56 couples to the inlet coupling 28, illustratively, via a gasket 78. Internally, the first diverter housing portion 56 includes an inlet 80 for receiving water from the inlet coupling 28. The inlet 80 couples to a passageway 82, and the passageway 82 couples to an outlet 84, which delivers water to the second diverter housing portion 58. Externally, the first diverter housing portion 56 includes two bosses 86 that are received in the notches 42 of the spout housing 36 to inhibit rotation between the first diverter housing portion 56 and the spout housing 36. The first diverter housing portion 56 also includes two additional bosses 88 that are described in further detail below. Proximate the outlet 84, the first diverter housing portion 56 includes a through hole 90 through which the sealing element 60 extends and in which the sealing element 60 is rotatably supported, illustratively, by a gasket 92. The first diverter housing portion 56 further includes a recess 94 in which the screw assembly 76 couples to the sealing element 60 and in which the screw assembly 76 rotates about the longitudinal axis 48. The recess 94 includes a side wall 96 that provides a stop that the screw assembly 76 abuts to define the first position.

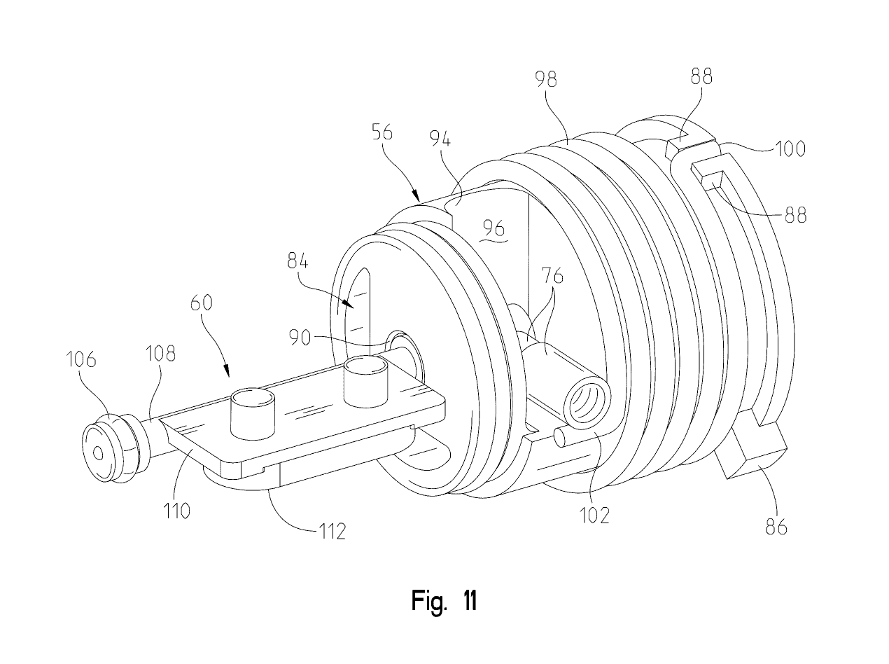

With continued reference to FIGS. 3-6 and additional reference to FIG. 11, the diverter assembly 20 further includes a torsion spring 98 that extends around the first diverter housing portion 56. Generally, the torsion spring 98 biases the handle 22 and the sealing element 60 toward the first position, and, as described in further detail below, the torsion spring 98 rotates the handle 22 and the sealing element 60 from the second position to the first position if the water pressure is less than a pressure threshold. Illustratively, the torsion spring 98 includes a first end 100 that couples to the first diverter housing portion 56 by being received between the bosses 88. The torsion spring 98 also includes a second end 102 that couples to the screw assembly 76, illustratively, by engaging a side of the screw assembly 76 that faces toward the second position. When the screw assembly 76 and the sealing element 60 are in the first position, the torsion spring 98 is relatively unloaded. When the screw assembly 76 and the sealing element are in the second position, the torsion spring 98 is relatively loaded. As a result, the torsion spring 98 biases the handle 22 and the sealing element 60 toward the first position. The torsion spring 98 may have a spring constant that is sufficient to facilitate operation of the diverter assembly 20 as described in further detail below.

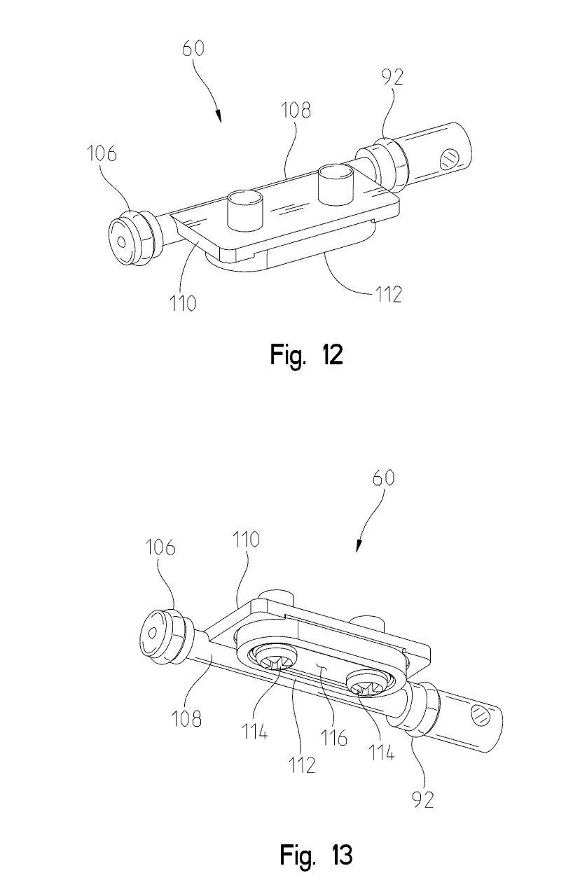

With reference to FIGS. 3-8 and 11-13, the sealing element 60 is rotatably coupled to the first diverter housing portion 56 and the second diverter housing portion 58, illustratively, via gaskets 92 and 106, respectively. The sealing element 60 includes a shaft 108 that extends along and is rotatable about the longitudinal axis 48. The shaft 108 couples to the screw assembly 76 within the recess 94 of the first diverter housing portion 56. The shaft 108 also couples to a blade or flap 110 that extends transversely away from the shaft 108. Illustratively, the flap 110 monolithically couples to the shaft 108. The flap 110 is disposed within the second diverter housing portion 58. The flap 110 couples to a gasket 112, illustratively, via fasteners (such as screws 114) and a plate 116. The gasket 112 illustratively has a three-dimensional generally planar oval shape, although it is contemplated that the gasket 112 may have other shapes. The gasket 112 is disposed apart from the longitudinal axis 48. In both the first and second positions, the gasket 112 is disposed in planes that are substantially perpendicular to the longitudinal axis 48. In addition, in the first position the gasket 112 is disposed apart from the diverter outlet 62 to permit water to flow through the tub spout assembly 10 and exit the tub spout assembly 10 via the spout outlet 24. In the second position the gasket 112 obscures the diverter outlet 62 to inhibit water from flowing through the spout outlet 24 of the tub spout assembly 10.

The surface area of the flap 110 opposite the gasket 112 may be configured such that pressure of the water within the diverter assembly 20 maintains the sealing element 60, and the handle 22, in the second position. That is, in the second position the surface area of the flap 110 opposite the gasket 112 and the pressure of the water within the diverter assembly 20 may provide a torque that is greater than torques acting in the opposite direction, such as the torque provided by the torsion spring 98. Illustratively, the surface area of the flap 110 opposite the gasket 112 is about 0.35 in² (that is, 0.35 in² within 10 percent) for a water pressure of 125 psi and a moment arm of 0.3 in. Similarly, for a given surface area of the flap 110 opposite the gasket 112, the pressure of the water within the diverter assembly 20 maintains the sealing element 60 and the handle 22 in the second position if the pressure is greater than a pressure threshold, and the torsion spring 98 rotates the sealing element 60 and the handle 22 to the first position if the pressure is less than the pressure threshold. These aspects are described in further detail below.

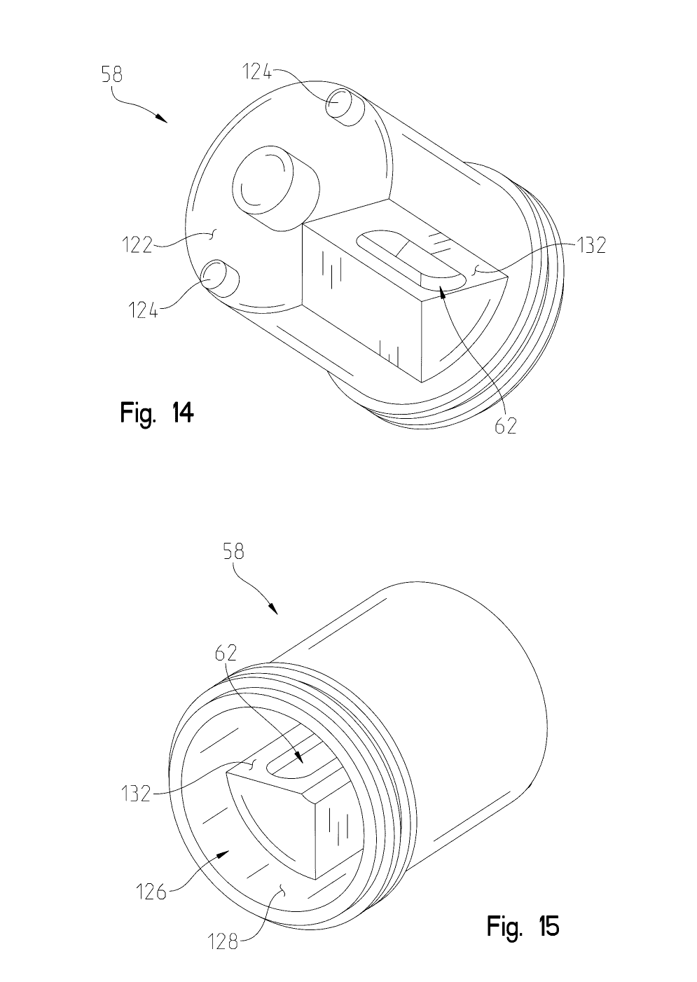

With reference to FIGS. 3-8, 14, and 15, the second diverter housing portion 58 couples to the first diverter housing portion 56 and the spout housing 36, illustratively, via gaskets 118 and 120, respectively. On an end wall 122 opposite the gaskets 118 and 120, the second diverter housing portion 58 includes bosses 124 that are received in the holes 51 in the transversely-extending internal wall 49 of the spout housing 36. The bosses 124 and the holes 51 thereby inhibit rotation between the second diverter housing portion 58 and the spout housing 36. Internally, the second diverter housing portion 58 includes an inlet 126 for receiving water from the first diverter housing portion 56. The inlet 126 couples to a passageway 128, and the passageway 128 couples to a blind hole 130 that rotatably receives the shaft 108 and gasket 112 of the sealing element 60. The passageway 128 also couples to the diverter outlet 62. Illustratively, the diverter outlet 62 has a generally oval shape. Alternatively, the diverter outlet 62 may have different shapes provided that the outlet 62 is smaller than the gasket 112. The diverter outlet 62 is defined by a wall 132, and the gasket 112 abuts the wall 132 around the diverter outlet 62 to inhibit water from flowing through the spout outlet 24 of the tub spout assembly 10 in the second position. Illustratively, the wall 132 and the diverter outlet 62 are disposed in a plane that is substantially perpendicular (that is, perpendicular within 5 degrees) to the longitudinal axis 48.

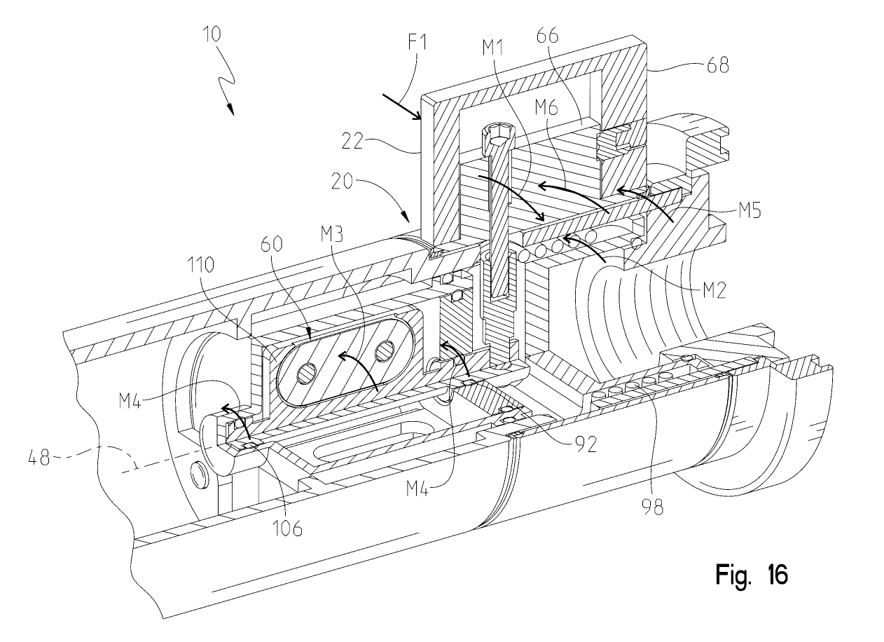

With reference to FIG. 16, when the diverter assembly 20 is in the first position, an operation torque M1 about the longitudinal axis 48 is applied to the handle 22 to rotate the handle 22 and the sealing element 60 to the second position. M1 must exceed the sum of the torques resisting rotation of the handle 22 and the sealing element 60 toward the second position. That is, M1 is as shown in equation 1.

M1>M2+M3+M4+M5+M6 (1)

where:

M2 is the torque about the longitudinal axis 48 provided by the torsion spring 98;

M3 is the torque about the longitudinal axis 48 caused by water pressure on the sealing element 60;

M4 is the torque about the longitudinal axis 48 caused by friction due to rotation of the gaskets 92 and 106;

M5 is the torque about the longitudinal axis 48 caused by friction due to rotation of the handle 22; and

M6 is the torque about the longitudinal axis 48 caused by the weight of the handle tab 66, the cover 68, and the flap 110.

M3 is as shown in equation 2.

M3=p·Aₛₑ·dₛₑ (2)

where:

p is the water pressure;

Aₛₑ is the total surface area of the sealing element 60 on which the water pressure acts; and

dₛₑ is the moment arm for the force p·Aₛₑ.

Illustratively, in the first position M2 is 3.7 in. lbs., M3 is zero, M4 is 0.1 in. lbs., M5 is 0.41 in. lbs., and M6 is zero. As a result, M1 must exceed 4.31 in. lbs. to rotate the handle 22 and the sealing element 60 from the first position to the second position. If an operation force F1 is applied to the cover 68 at a distance d1 from the longitudinal axis 48, F1 is as shown in equation 3.

F1=M1/d1 (3)

### Illustratively, if d1 is 1.53 in., F1 is 2.82 lbs.

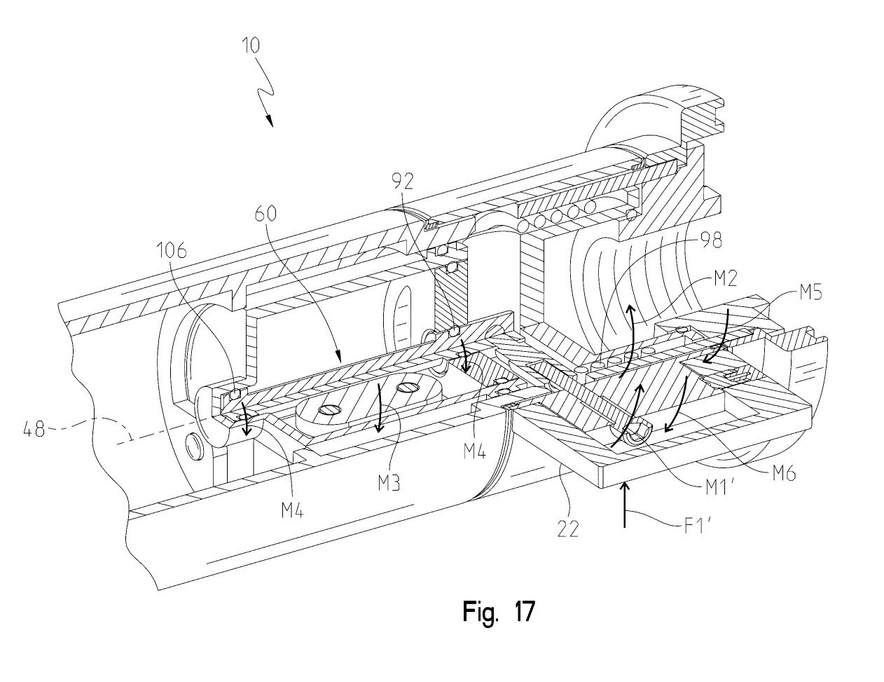

As described briefly above, when the diverter assembly 20 is in the second position, the diverter assembly 20 may be moved to the first position by (1) applying an operation torque M1′ to the handle 22 about the longitudinal axis 48 while water is delivered through the shower head, or (2) reducing the water pressure below a pressure threshold. With reference to FIG. 17, in the case of applying the operation torque M1′ to the handle 22, M1′ is as shown in equation 4.

M1′>(−M2)+M3+M4+M5+M6 (4)

Illustratively, in the second position M2 is 3.7 in. lbs., M3 is 13.13 in. lbs. (p is 125 psi, Aₛₑ is 0.35 in², and dₛₑ is 0.3 in.), M4 is 0.1 in. lbs., M5 is 0.41 in. lbs., and M6 is 0.1 in. lbs. As a result, M1′ must exceed 10.04 in. lbs. to rotate the handle 22 and the sealing element 60 from the second position to the first position while water is delivered through the shower head. If an operation force F1′ is applied to the cover 68 at a distance dl from the longitudinal axis 48, F1′ is as shown in equation 5.

F1′=M1′/d1 (5)

### Illustratively, if d1 is 1.53 in., F1′ is 6.56 lbs.

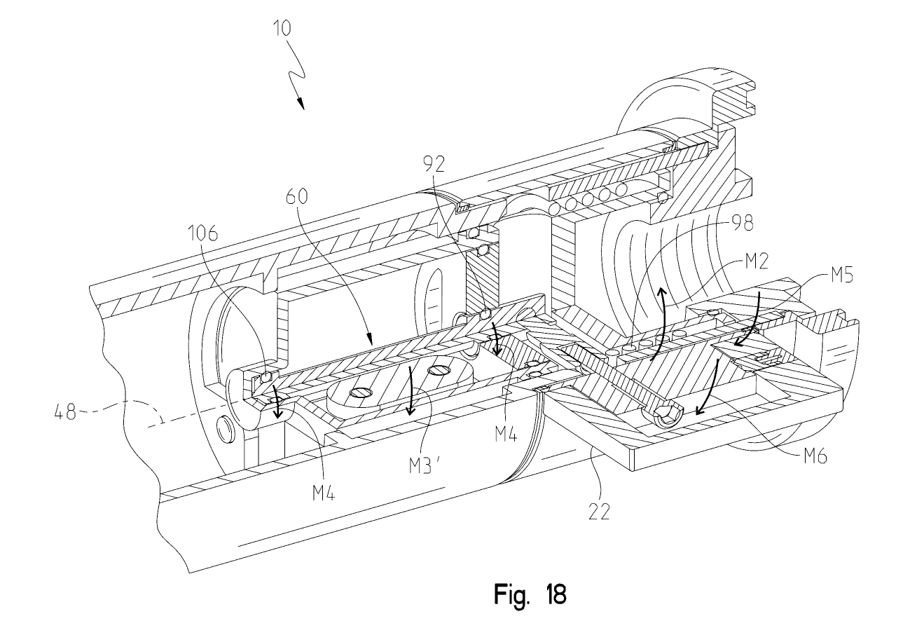

With reference to FIG. 18 and in the case of reducing the water pressure below a pressure threshold, pₜ, M3′, the torque about the longitudinal axis 48 caused by pₜ on the sealing element 60, is as shown in equations 6 and 7.

M3′=pₜ Aₛₑ·dₛₑ (6)

M3′=M2−M4−M5−M6 (7)

As a result, pₜ is as shown in equation 8.

pₜ=(M2−M4−M5−M6)/Aₛₑ·dₛₑ (8)

Illustratively, for the values provided above, pₜ is 29.4 psi. That is, the water pressure must be less than 29.4 psi to permit the torsion spring 98 to rotate the handle 22 and the sealing element 60 from the second position to the first position.

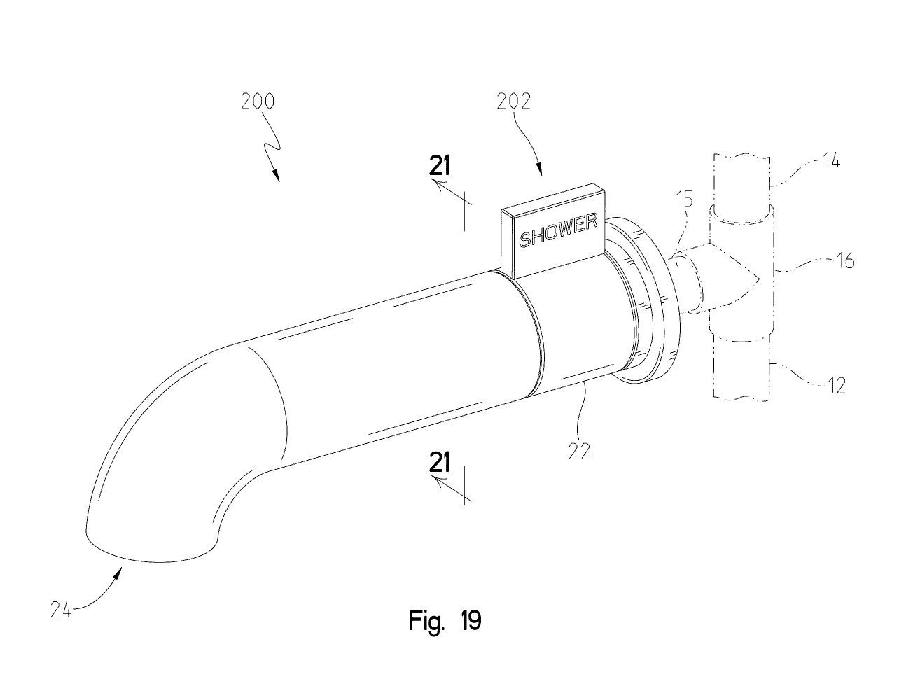

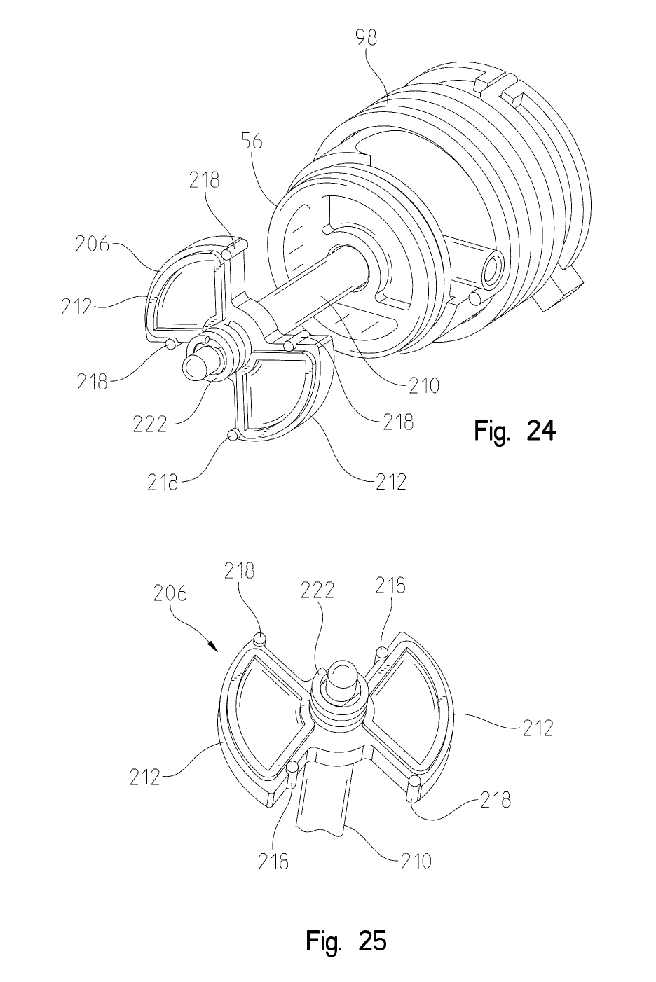

With reference now to FIGS. 19-27 of the drawings, another illustrative tub spout assembly 200 of the present disclosure is configured to couple to a water delivery pipe or riser 12 and a shower head pipe or riser 14 via a tub spout pipe 15 and a T-joint 16. The tub spout assembly 200 includes many of the same, or similar, components as the tub spout assembly 10 described above. For brevity, descriptions of the same, or similar, components as the tub spout assembly 10 are not provided in connection with FIGS. 19-27. However, the tub spout assembly 200 includes a diverter assembly 202 that differs from the diverter assembly 20 described above. Specifically, the diverter assembly 202 includes a second diverter housing portion 204 and a sealing element 206 that differ from the components described above.

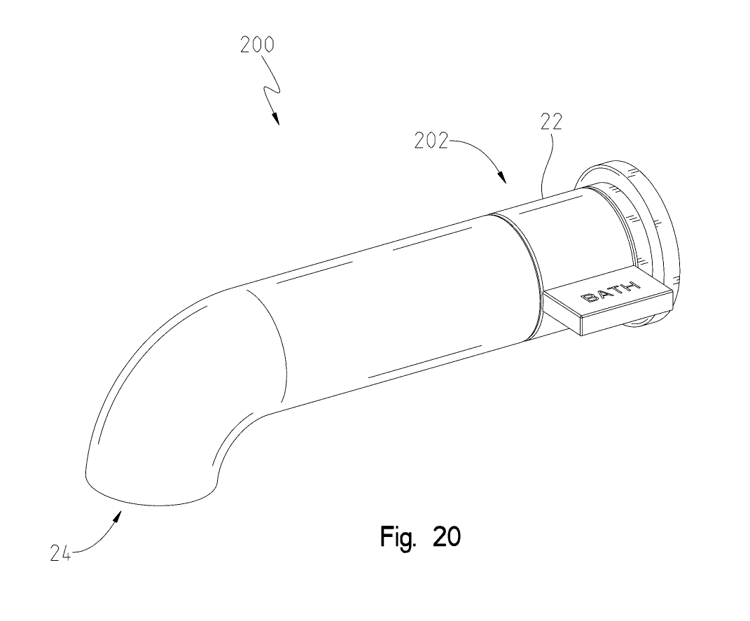

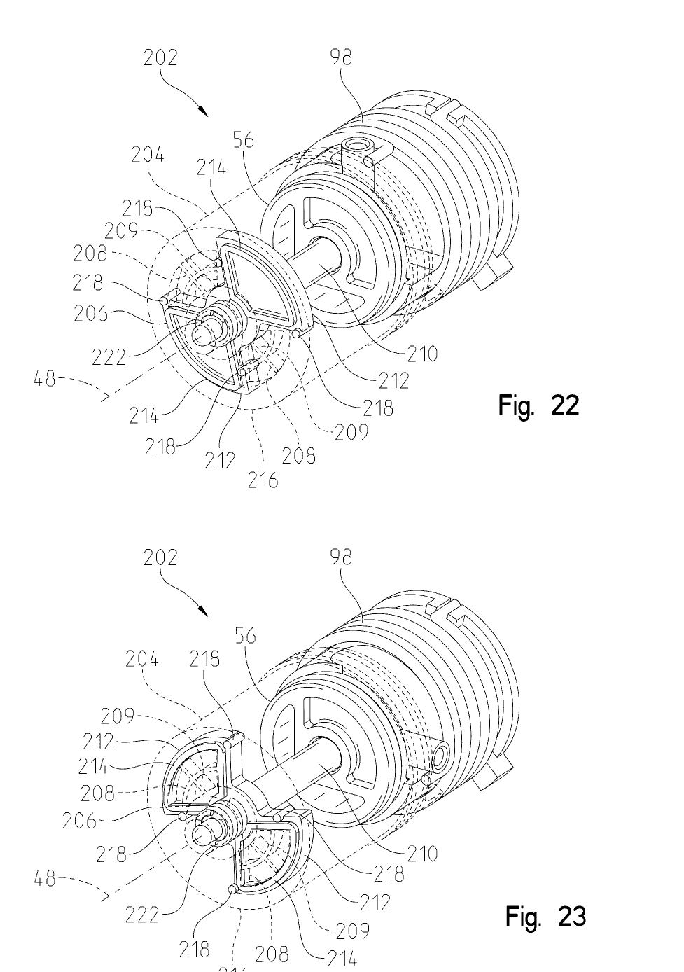

Generally, the housing portions 56 and 204 rotatably and internally carry the sealing element 206. The sealing element 206 couples to the handle 22 so as to rotate with the handle 22 from the first position (for example, the “bath”, or “tub” position; see FIGS. 19 and 22) to the second position (for example, the “shower” position; see FIGS. 20 and 23) and vice versa. In the first position, the sealing element 206 is disposed apart from a diverter outlet 208 defined by the second diverter housing portion 204 to permit water to flow through the tub spout assembly 200 and exit via the spout outlet 24. In the second position, the sealing element 206 obscures the diverter outlet 208 to inhibit water from flowing through the spout outlet 24 of the tub spout assembly 200. Illustratively, the diverter outlet 208 includes two portions 209 that are diametrically opposed to each other about the longitudinal axis 48. Each portion 209 of the outlet 208 illustratively has a three-dimensional “pie slice” shape or sector, with an angular width about 90 degrees (that is, 90 degrees±15 degrees), although it is contemplated that the portions 209 of the outlet 208 may have other shapes.

The sealing element 206 includes a shaft 210 that extends along and is rotatable about the longitudinal axis 48. The shaft 210 also couples to one or more blade or flaps 212 (illustratively, two flaps 212) that extend away from the shaft 210. Illustratively, the flaps 212 are diametrically opposed to each other about the longitudinal axis 48. The surface area of the flaps 212 to which water applies a pressure may be considered in view of a pressure threshold (see below). Each flap 212 couples to a gasket 214. Each gasket 214 illustratively has a three-dimensional “pie slice” shape or sector, with an angular width about 90 degrees (that is, 90 degrees±15 degrees), although it is contemplated that the gaskets 214 may have other shapes. In both the first and second positions, the gaskets 214 are disposed a plane that is substantially parallel to the longitudinal axis 48. In addition, in the first position each gasket 214 is disposed apart from a corresponding portion of the diverter outlet 208 (which illustratively include similar three-dimensional pie slice shapes and angular widths) to permit water to flow through the tub spout 200 and exit the tub spout 200 via the spout outlet 24. In the second position each gasket 214 obscures the corresponding portion of diverter outlet 208 to inhibit water from flowing through the spout outlet 24 of the tub spout 200.

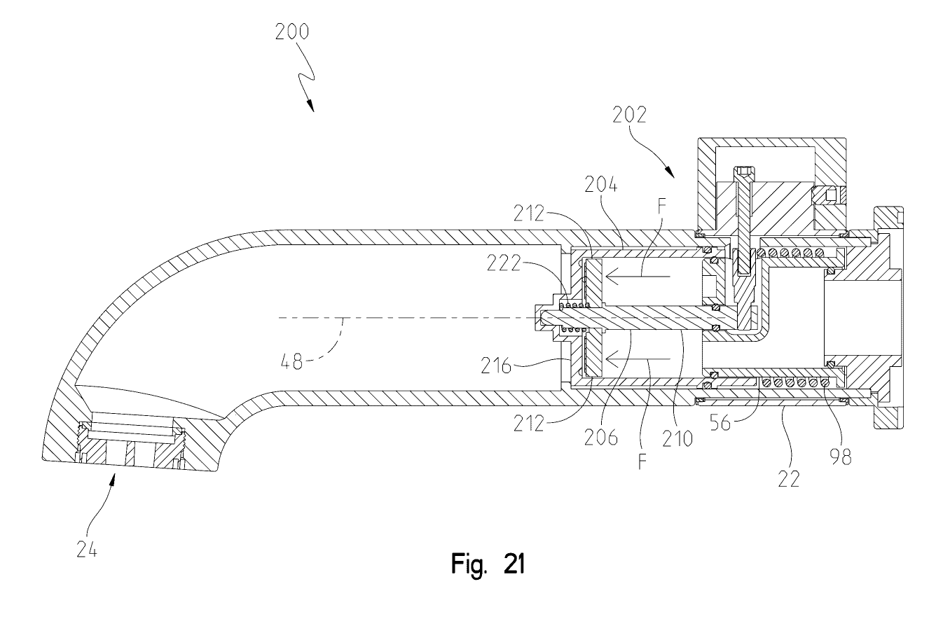

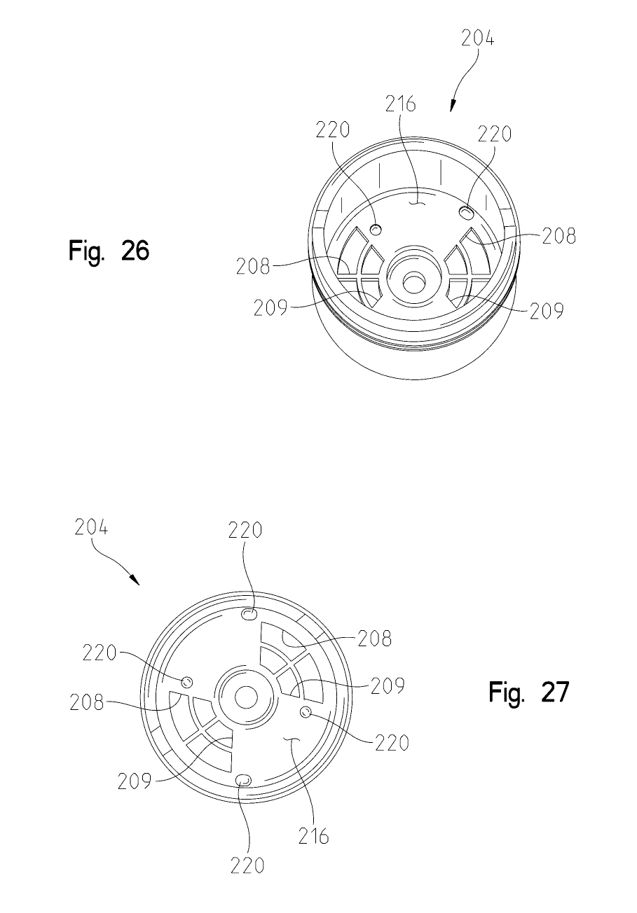

In a similar manner to the diverter assembly 20 described above, the torsion spring 98 is configured to rotate the sealing element 206 and the handle 22 to the first position under certain conditions. For this purpose, the sealing element 206 is translatable along the longitudinal axis 48 relative to the first diverter housing portion 56 and the second diverter housing portion 204. When the pressure within the assembly 200 (which applies a force F to the flaps 212 of the sealing element 206; see FIG. 21) is above a threshold and as shown in FIGS. 21-23, the sealing element 206 abuts an end wall 216 of the second diverter housing portion 204 that defines the outlet 208. When the pressure is above the threshold and when the handle 22, and therefore the sealing element 206, rotate to the second position (for example, due to manual manipulation by a user), the sealing element 206 and the second diverter housing portion 204 engage one or more rotation-inhibiting elements to inhibit the sealing element 206 from rotating to the first position (for example, due to the torque applied by the torsion spring 98). Illustratively, the rotation-inhibiting elements include protrusions 218 formed on the flaps 212 and recesses 220 formed on the inner surface of the end wall 216 (see FIGS. 26 and 27) and for receiving the protrusions 218. The rotation-inhibiting element(s) could take other forms. For example, recesses could be formed on the flaps and protrusions could be formed on the inner surface of the end wall 216 of the second diverter housing portion 204. In any case, when the pressure falls below the threshold, a compression spring 222 carried by the shaft 210 urges the sealing element 206 to translate away from the end wall 216 of the second diverter housing portion 204, and the rotation-inhibiting elements disengage. When the rotation-inhibiting elements disengage, the torque applied by the torsion spring 98 rotates the sealing element 206 and the handle 22 to the first position.

Various modifications and additions can be made to the embodiments described above without departing from the scope of the present disclosure. For example, while the embodiments described above refer to particular features, the scope of this disclosure also includes embodiments having different combinations of features and embodiments that do not include all of the above described features.

The following is claimed:

1. A tub spout assembly for delivering water and diverting water to a shower head, the tub spout assembly comprising:
a tub spout comprising:
a spout inlet configured to receive water;
a spout outlet configured to deliver water from the tub spout assembly; and
a diverter assembly carried by the tub spout, the diverter assembly comprising:
a diverter inlet configured to receive water from the spout inlet;
a diverter outlet configured to deliver water to the spout outlet;
a handle rotatably carried by the tub spout, the handle being rotatable from a first position to a second position and vice versa relative to the tub spout;
a sealing element coupled to the handle so as to rotate with the handle from the first position to the second position and vice versa relative to the tub spout, in the first position the sealing element being disposed apart from the diverter outlet to permit water to flow through the tub spout assembly and exit the tub spout assembly via the spout outlet, and in the second position the sealing element obscuring the diverter outlet to inhibit water from flowing through the spout outlet of the tub spout assembly; and
a torsion spring coupled to the handle and the sealing element, the torsion spring biasing the handle and the sealing element toward the first position.

2. The tub spout assembly of claim 1, wherein the torsion spring comprises a spring constant, the sealing element comprises a surface area against which water applies a pressure when the sealing element is in the second position, the spring constant and the surface area being configured such that (1) the pressure maintains the sealing element in the second position when the pressure is greater than a pressure threshold; and (2) the torsion spring rotates the handle and the sealing element to the first position when the pressure is less than the pressure threshold.

3. The tub spout assembly of claim 1, wherein the diverter assembly further includes a diverter housing carried by the tub spout, the diverter housing comprising the diverter inlet, the diverter outlet, and rotatably carrying the sealing element, wherein the torsion spring comprises:
a first end coupled to the diverter housing; and
a second end coupled to the handle.

4. The tub spout assembly of claim 1, wherein the tub spout further comprises a longitudinal axis, the handle and the sealing element being rotatable about the longitudinal axis from the first position to the second position and vice versa relative to the tub spout.

5. The tub spout assembly of claim 4, wherein the handle and the sealing element rotate substantially 90 degrees about the longitudinal axis from the first position to the second position and vice versa.

6. The tub spout assembly of claim 4, wherein the diverter outlet is disposed in a plane that is substantially perpendicular to the longitudinal axis.

7. The tub spout assembly of claim 4, wherein the sealing element comprises:
a shaft coupled to the handle, the shaft extending along the longitudinal axis; and
a flap coupled to the shaft;
a gasket coupled to the flap and disposed apart from the longitudinal axis, in the first position the gasket being disposed apart from the diverter outlet to permit water to flow through the tub spout assembly and exit the tub spout assembly via the spout outlet, and in the second position the gasket obscuring the diverter outlet to inhibit water from flowing through the spout outlet of the tub spout assembly.

8. The tub spout assembly of claim 1, wherein the diverter assembly further comprises a diverter housing carried by the tub spout, the diverter housing rotatably carrying the sealing element, the diverter housing comprising a wall that defines the diverter outlet, and wherein in the second position the sealing element abuts the wall around the diverter outlet to inhibit water from flowing through the spout outlet of the tub spout assembly.

9. The tub spout assembly of claim 1, wherein the tub spout further comprises a spout housing that defines a partially circumferentially-extending slot extending through the spout, and the handle including a lever extending through the slot and coupled to the sealing element.

10. The tub spout assembly of claim 9, wherein the handle obscures the partially circumferentially-extending slot.

11. A tub spout assembly for delivering water and diverting water to a shower head, the tub spout assembly comprising:
a tub spout defining a longitudinal axis, the tub spout comprising:
a spout inlet configured to receive water;
a spout outlet configured to deliver water from the tub spout assembly; and
a diverter assembly carried by the tub spout, the diverter assembly comprising:
a diverter inlet configured to receive water from the spout inlet;
a diverter outlet configured to deliver water to the spout outlet, the diverter outlet being disposed in a plane that is substantially perpendicular to the longitudinal axis;
a handle rotatably carried by the tub spout, the handle being rotatable from a first position to a second position and vice versa relative to the tub spout about the longitudinal axis; and
a sealing element coupled to the handle so as to rotate with the handle from the first position to the second position and vice versa relative to the tub spout about the longitudinal axis, in the first position the sealing element being disposed apart from the diverter outlet to permit water to flow through the tub spout assembly and exit the tub spout assembly via the spout outlet, and in the second position the sealing element obscuring the diverter outlet to inhibit water from flowing through the spout outlet of the tub spout assembly.

12. The tub spout assembly of claim 11, wherein the handle and the sealing element rotate substantially 90 degrees about the longitudinal axis from the first position to the second position and vice versa.

13. The tub spout assembly of claim 11, wherein the sealing element comprises:
a shaft coupled to the handle, the shaft extending along the longitudinal axis; and
a flap coupled to the shaft;
a gasket coupled to the flap and disposed apart from the longitudinal axis, in the first position the gasket being disposed apart from the diverter outlet to permit water to flow through the tub spout assembly and exit the tub spout assembly via the spout outlet, and in the second position the gasket obscuring the diverter outlet to inhibit water from flowing through the spout outlet of the tub spout assembly.

14. The tub spout assembly of claim 13, wherein the diverter assembly further comprises a torsion spring coupled to the handle and the sealing element, the torsion spring biasing the handle and the sealing element toward the first position, the torsion spring comprising a spring constant, the sealing element comprising a surface area against which water applies a pressure when the sealing element is in the second position, the spring constant and the surface area being configured such that (1) the pressure maintains the sealing element in the second position when the pressure is greater than a pressure threshold; and (2) the torsion spring rotates the handle and the sealing element to the first position when the pressure is less than the pressure threshold.

15. The tub spout assembly of claim 14, wherein the handle and the sealing element rotate substantially 90 degrees about the longitudinal axis from the first position to the second position and vice versa.

16. The tub spout assembly of claim 11, wherein the diverter assembly further comprises a diverter housing carried by the tub spout, the diverter housing rotatably carrying the sealing element, the diverter housing comprising a wall that defines the diverter outlet, and wherein in the second position the sealing element abuts the wall around the diverter outlet to inhibit water from flowing through the spout outlet of the tub spout assembly.

17. A tub spout assembly comprising:
a tub spout including:
a spout inlet configured to receive water;
a spout outlet configured to deliver water from the tub spout assembly; and
a diverter assembly supported by the tub spout, the diverter assembly including:
a diverter inlet configured to receive water from the spout inlet;
a diverter outlet configured to deliver water to the spout outlet;
a handle rotatably supported by the tub spout, the handle being rotatable between a first position and a second position relative to the tub spout;
a sealing element coupled to the handle so as to rotate with the handle between the first position and the second position relative to the tub spout, in the first position the sealing element being disposed apart from the diverter outlet to permit water to flow through the spout outlet of the tub spout assembly, and in the second position the sealing element obscuring the diverter outlet to inhibit water from flowing through the spout outlet of the tub spout assembly; and
a torsion spring coupled to the handle and the sealing element, the torsion spring biasing the handle and the sealing element toward the first position.

18. The tub spout assembly of claim 17, wherein the tub spout further comprises a longitudinal axis, the handle and the sealing element being rotatable about the longitudinal axis from the first position to the second position and vice versa relative to the tub spout.

19. The tub spout assembly of claim 19, wherein the diverter outlet is disposed in a plane that is substantially perpendicular to the longitudinal axis.

20. The tub spout assembly of claim 19, wherein the sealing element comprises:
a shaft coupled to the handle, the shaft extending along the longitudinal axis; and
a flap coupled to the shaft;
a gasket coupled to the flap and disposed apart from the longitudinal axis, in the first position the gasket being disposed apart from the diverter outlet to permit water to flow through the tub spout assembly and exit the tub spout assembly via the spout outlet, and in the second position the gasket obscuring the diverter outlet to inhibit water from flowing through the spout outlet of the tub spout assembly.

21. The tub spout assembly of claim 17, wherein the tub spout further comprises a spout housing that defines a partially circumferentially-extending slot extending through the spout, and the handle including a lever extending through the slot and coupled to the sealing element.
